(19) United States
(12) Patent Application Publication
(10) Pub. No.: US 2009/0066957 A1
(43) Pub. Date: Mar. 12, 2009

(54) Method and Apparatus for Sensing a Target Substance by Analysing Time Series of Said Target Substance

(76) Inventor: Andrew Mark Shaw, Exetor Devon (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/658,187

(22) PCT Filed: Jul. 18, 2005
(86) PCT No.: PCT/GB05/50112

§ 371 Date: Mar. 14, 2008

(30) Foreign Application Priority Data
Jul. 22, 2004 (GB) 0416372.1

(51) Int. Cl. G01N 21/59; G01N 21/55

(52) U.S. Cl. 356/437; 702/24; 356/445

(57) ABSTRACT

This invention is concerned with apparatus, methods and computer program code for sensing a target substance using one or more very high sensitivity optical sensors such as sensors employing evanescent waves and/or cavity ring-down techniques. The methods and apparatus we describe are particularly useful in reducing false alarm rates.

A method of detecting a target substance using an optical sensor, the method comprising: repeatedly measuring a level of said target, with said optical sensor to provide a time series of target levels; determining a first derivative of said target level time series with respect to time and outputting a target detection signal responsive to a profile of said first derivative time series data.

This invention is concerned with apparatus, methods and computer program code for sensing a target substance using one or more very high sensitivity optical sensors such as sensors employing evanescent wave and/or cavity ring-down techniques. The methods and apparatus we describe are particularly useful in reducing false alarm rates.

Cavity Ring-Down Spectroscopy is known as a high sensitivity technique for analysis of molecules in the gas phase (see, for example, G. Berden, R. Peeters and G. Meijer, Int. Rev. Phys. Chem., 19, (2000) 565, P. Zalicki and R. N. Zare, J. Chem. Phys. 102 (1995) 2708, M. D. Levinson, B. A. Paldus, T. G. Spence, C. C. Harb, J. S. Harris and R. N. Zare, Chem. Phys. Lett. 290 (1998) 335, B. A. Paldus, C. C. Harb, T. G. Spence, B. Wilkie, J. Xie, J. S. Harris and R. N. Zare, J. App. Phys. 83 (1998) 3991. D. Romanini, A. A. Kachanov and F. Stoeckel, Chem. Phys. Lett. 270 (1997) 538). The CRDS technique can readily detect a change in molecular absorption coefficient of 10⁻⁶ cm⁻¹, with the additional advantage of not requiring calibration of the sensor at the point of measurement since the technique is able to determine an absolute molecular concentration based upon known molecular absorbance at the wavelength or wavelengths of interest. Although the acronym CRDS makes reference to spectroscopy in many cases measurements are made at a single wavelength rather than over a range of wavelengths.

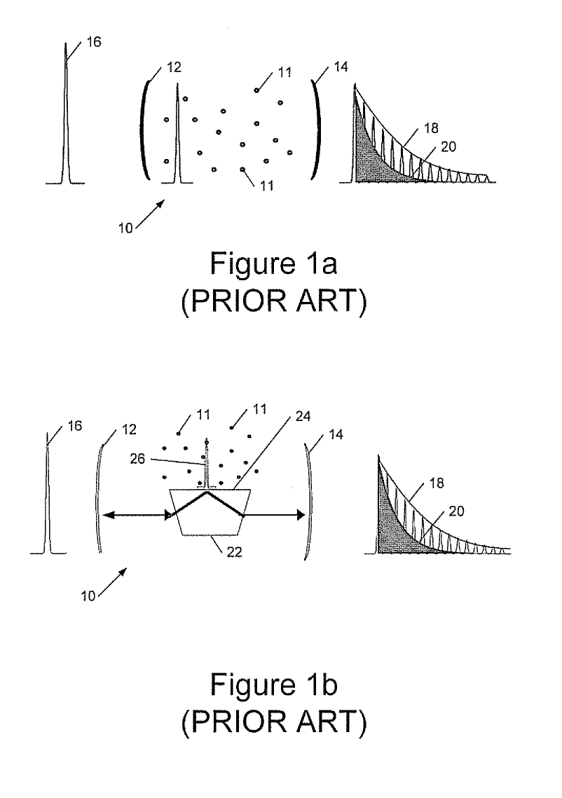

FIG. 1a, which shows a cavity 10 of a CRDS device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, τ. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time τ is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, Δτ, is a function of the strength of absorption of the molecule at the frequency, v, of interest α(v) (the molecular extinction coefficient) and of the concentration per unit length, lₛ, of the absorbing species and is given by equation 1 below.

Δτ=tᵣ/{2(1−R)+α(v)lₛ} (Equation 1)

where R is the reflectivity of each of mirrors 12, 14 and tᵣ is the round trip time of the cavity, tᵣ=c/2 L where c is the speed of light and L is the length of the cavity. Since the molecular absorption coefficient is a property of the target molecule, once Δτ has been measured the concentration of molecules within the cavity can be determined without the need for calibration.

It will be appreciated that to employ equation 1 measurements of the mirror reflectivities, the molecular absorption (or extinction) coefficient, the cavity length and (where different) the sample lengths are necessary but these may be determined in advance of any particular measurement, for example, during initial set up of a CRDS machine. Likewise since the decay times are generally relatively short, of the order of tens of nanoseconds, a timing calibration may also be needed, although again this may be performed when the apparatus is initially set up.

It will be further appreciated that to achieve a high sensitivity the reflectivities of mirrors 12, 14 should be high (whilst still permitting a detectable level of light to leak out) and typically R equals 0.9999 to provide of the order of 104 bounces. If the total losses in the cavity are around 1% there will only be 3 or 4 bounces and consequently the sensitivity of the apparatus is very much reduced; in practical terms it is desirable to have total losses less than 0.25%, corresponding to around 200 bounces during decay time τ, or approximately 1000 bounces during ring down of the entire cavity.

One problem with CRDS is that the technique is only suitable for sensing molecules that are introduced into the cavity in a gas since if a liquid or solid is introduced into the cavity losses become very large and the technique fails. To address this problem so-called evanescent wave CRDS (e-CRDS) can be employed, as described in the Applicant's co-pending UK patent application no. 0302174.8 filed 30 Jan. 2003. Background prior art relating to e-CRDS can be found in U.S. Pat. No. 5,943,136, U.S. Pat. No. 5,835,231 and U.S. Pat. No. 5,986,768.

FIG. 1b, in which like elements to those of FIG. 1a are indicated by like reference numerals, shows the idea underlying evanescent wave CRDS. In FIG. 1b a prism 22 (as shown, a pellin broca prism) is introduced into the cavity such that total internal reflection (TIR) occurs at surface 24 of the prism (in some arrangements a monolithic cavity resonator may be employed). Total internal reflection will be familiar to the skilled person, and occurs when the angle of incidence (to a normal surface) is greater than a critical angle θ_{c} where sin θ_{c} is equal to n₂/n₁ where n₂ is the refracted index of the medium outside the prism and n₁ is the refractive index of the material of which the prism is composed. Beyond this critical angle light is reflected from the interface with substantially 100% efficiency back into the medium of the prism, but a non-propagating wave, called an evanescent wave (e-wave) is formed beyond the interface at which the TIR occurs. This e-wave penetrates into the medium above the prism but it's intensity decreases exponentially with distance from the surface, typically over a distance of the order of the a wavelength. The depth at which the intensity of the e-wave falls to 1/e (where e=2.718) of it's initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules in a gaseous phase. In the configuration of FIG. 1b molecules near the total internal reflection surface 24 are effectively in optical contact with the cavity, and are sampled by the e-wave resulting from the total internal reflection at the surface.

The sensitivity of CRDS-type apparatus can tailored to a particular application by providing a functionalising material within the optical cavity, more particularly on an ATIR surface as described in the applicant's UK patent application No. 0405823.6 filed 15 Mar. 2004, hereby incorporated by reference. However one potentially important application area for sensors of this general type is that of monitoring for toxic chemical or biological agents to warn of a terrorist attack. In this and similar application areas the false alarm rate becomes important, particularly where the sensitivity is very high, and even when some degree of specificity is present. Potentially sensors of the cavity absorption and/or evanescent wave type could be of great benefit in such applications but there is a need to minimise the false alarm rate in an operational scenario.

According to a first aspect of the present invention there is therefore provided a method of detecting a target substance using an optical sensor, the method comprising: repeatedly measuring a level of said target, with said optical sensor to provide a time series of target levels; determining a first derivative of said target level time series with respect to time; and outputting a target detection signal responsive to a profile of said first derivative time series data.

In embodiments monitoring the first derivative of the time series of target substance levels, what is later referred to as an “attack profile”, preferably in real time, enables the likelihood of false alarms to be reduced. It also facilitates detection of the target using a cumulative or integration sensor in which the signal from which rises continuously during exposure to the target. The target detection signal may be provided responsive to an attack time of the profile or to a duration of a peak in the profile, or to a peak height, or to an increase in the first derivative value above a threshold level, or to a combination of these. The profile to which the target detection signal is responsive may be determined, for example, by calibrating a sensor system in the environment in which it is used or in a similar environment, or by computer modelling.

In a real-world system in order to accurately determine an attack profile for the target substance it is preferable that measurements of a level of the target are made at least ten times faster than a characteristic time associated with diffusion or other transport of the target substance, a suitable characteristic time being defined by the time it takes for the target substance to diffuse across a sensing surface or sensing region of the sensor. This time is typically of the order of seconds (for example chlorine diffuses at approximately 1 mm per second) although for a gas sensor bulk transport such as that caused by air currents around a room can affect this. A preferred repetition rate for the measurements is therefore at least 10 Hz, more preferably at least 100 Hz, 1 KHz, or 10 KHz. Preferably the sensor should be fast enough to respond at these frequencies and we later describe how such sensors may be implemented using evanescent wave CRDS technology.

The aforementioned bulk transport can modify an attack profile triggering a target detection signal, and such effects can be taken into account for a specific locality by a calibration procedure to further reduce the false alarm rate and/or to achieve a desired balance between probability of detection and probability of false alarm. The repetition rate and attack profile for target detection may also be modified depending upon the target to be detected, for example, an aerosol of say a nerve agent tending to diffuse more slowly than a gas. Target detection is not limited to gas phase materials and embodiments of the above-described methods can also be used, for example, to detect residue from a dirty bomb within a water supply, in which case a suitable attack profile and measurement rate may be selected by routine experimentation.

The target detection signal may indicate presence of the target at greater than a threshold level, for example, to warn of an attack, and additionally or alternatively may provide an “all clear” or decontamination signal to indicate when presence of the target substance has fallen back to a safe level. The thresholds for warning of an attack and for providing an “all clear” warning may be different, for example to provide a rapid alarm and to provide a signal indicating safety for extended exposure.

Where the sensor is a cumulative sensor the output from the sensor will continue to rise even after the level of the target has fallen back to a safe level; this can be identified by a change in the slope of the first derivative from a large slope when a high level of the target is present to a smaller slope when a lower level of the target is present. This change in slope may be identified by a change in sign of a second derivative (with respect to time) of the target level measurements. Thus the target detection signal may also be responsive to a second derivative of the time series of target levels and, optionally, the target detection signal may be provided in response to the second derivative having a particular type of profile, in a similar manner to that described above with reference to the first derivative.

Where both an “attack” and an “all clear” signal are desirable it is helpful to use more than one type of sensor, or equivalently, a sensor having more than one sensing region or surface, one sensor or region being suitable for sensing an increasing level of the target, and a second sensor or region for sensing a decreasing level of the target. More particularly the sensor or sensing region being suitable for sensing a decreasing level of the target may have a higher saturation threshold so that it is able to follow reduction of the target back down to safe level after exposure to enhanced levels of the target.

In a similar way in embodiments the sensor may comprise a plurality of sensors or sensing regions of different sensitivity or sensitivity ranges, optionally overlapping, to provide both sensitive initial detection and the ability to follow an attack profile in which the target is present at relatively high levels. For example for chlorine detection one sensor may detect at, say, 4 ppm, another in the range 100 to 1000 ppm, and a third may be provided with the ability to follow the target level back down to 4 ppm, a safe level. Optionally the sensors or sensing surfaces or regions may comprise a control sensor or control surface/region for, say, compensating a baseline, and/or a binary target detection sensor or region/surface (signals from which are processed to provide a binary output depending upon whether the target is present or not). The output(s) of one or more of these may be combined with the profile-responsive signal for increased confidence of target detection.

In embodiments a plurality of optical sensors may be disposed, spaced apart, along a path to track motion (diffusion or other transport) of the target substance along the path. Target detection may then be made dependent upon target detection signals being received from the sensors (and their associated processing) in a sequence defining, for example, expected motion of the target through the environment in which the sensors are placed. By combining the target detection signals in this way and thus excluding physically implausible sequences of signals the false alarm rate may again be reduced. Sensors may be spaced either horizontally, to detect transport along a horizontal path and/or vertically depending upon the target to be sensed and its density relative to the surrounding medium. For example some gases, for example chlorine, sink in air and therefore vertically distributed sensors might be expected to show a bias in target detection, lower sensors being more likely to sense the target than higher sensors. This observation may be generalised and the provision of a target detection signal may be dependent upon an expected distribution in space and/or time of first or second derivative signals from the sensors and/or individual target detection outputs based upon a profile of these.

Preferably, as previously mentioned, an optical sensor for use in the above methods comprises an optical cavity absorption sensor, preferably incorporating evanescent-wave-based sensing, particularly preferably of the cavity ring-down type.

The skilled person will appreciate that embodiments of the above described methods may be implemented using computer program code to process a signal from the optical sensor. Examples of this are described in more detail later. Such computer program (or processor control) code may be provided on a carrier such as a CD- or DVD-ROM or on read only memory (Firmware) or as a signal on an optical or electrical signal carrier. Such computer program code may be written in any conventional programming language and may be distributed between a plurality of coupled components, for example over a network.

In a related aspect the invention also provides apparatus for detecting a target substance using an optical sensor, the apparatus comprising: an input to receive a signal from said optical sensor; means to repeatedly determine a level of said target with said optical sensor to provide a time series of target levels; means to determine a first derivative of said target level time series with respect to time to provide first derivative time series data; and means to output a target detection signal responsive to a profile of said first derivative time series data.

Again, as previously mentioned, the optical sensor may comprise a cumulative or integration sensor, preferably of the optical cavity and/or evanescent wave-based type. Preferably the apparatus is configured to make repeated target level determinations at a frequency of at least 10 Hz, more preferably at a frequency of at least 1 KHz. As previously described a sensor (system) may comprise a plurality of sensing portions with different, preferably overlapping ranges, and/or different saturation levels to facilitate detecting a range of levels of the target substance and to facilitate detection of a reduction in a level of the target substance following an increased level. Again for this latter purpose preferably the apparatus also includes means to determine a second derivative (with respect to time) of the time series of target levels. Optionally, as mentioned above, the apparatus may include or have inputs from a plurality of sensors disposed along a path and may be configured to provide a target detection output signal in response to the identification of a target pattern of processed sensor signals in either time and/or space (the process sensor signal preferably being derived according to the above described methods). Such sensors may conveniently be multiplexed and, for example, addressed using a signal fibre optic cable using wavelength division or other multiplexing techniques as described in more detail in the applicant's co-pending UK patent application No. 0405820.2 filed 15 Mar. 2004, the contents of which are hereby incorporated in their entirety by reference.

As the skilled person will appreciate the above described methods and apparatus are suitable for detecting gas, liquid and/or solid phase target substances. The above described techniques are not limited to use with optical sensors and can be of benefit when employed with sensors of other types, particularly types having a high detection sensitivity, and therefore in the above described methods and apparatus references to an optical sensor may be replaced by references to merely a sensor (of any type).

We also describe herein an evanescent wave cavity-based optical sensor, the sensor comprising: an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function; a light source to inject light into said cavity; and a detector to detect a light level within said cavity; and wherein said TIR surface is provided with a functionalising material over at least part of said TIR surface such that said evanescent wave interacts with said material; whereby an interaction between said functionalising material and a target to be sensed is detectable as a change in absorption of said evanescent wave. The sensed target may be biological or non-biological, living or non-living, examples including elements, ions, small and large molecules, groups of molecules, and bacteria and viruses. The target may comprise a single substance, species or entity or a group of substances, species or entities.

Functionalising the TIR surface, for example by depositing onto it a material which has a selective response to the target or target group facilitates a more specific and selective response from the sensor, which is useful because of the very high sensitivity of the technique. In some instances this already high sensitivity may even be increased. Broadly speaking the evanescent wave at the TIR surface is modified by the functionalising material, giving rise to a change in the change in the cavity characteristics, in particular the ring-down (or up) time, when a target is attached, bound or otherwise adjacent the functionalising material, which in preferred embodiments comprises a chromophore.

We also describe herein an evanescent wave cavity ring-down sensor comprising: a ring-down optical cavity including an attenuated total-internal-reflection (ATIR) based sensing device for sensing a substance modifying a ring-down characteristic of the cavity; a continuous wave light source for exciting said cavity; and a detector for monitoring said ring-down characteristic; and wherein said sensing device includes an ATIR interface to which is attached a material which has a selective response to a target such that an evanescent wave at said interface is modified by said target to modify said cavity ring-down characteristic.

In preferred arrangements the functionalising material is attached to the TIR surface or interface, for example by means of a molecular tether or link but alternative deposition techniques may also be employed. The functionalising material may comprise a molecular material, preferably including a chromophore with an absorption at the wavelength of the light within the cavity, for example a host for a guest species or ligand. The material may include a molecular tether, link or chain for attaching it to the surface or interface; where the surface/interface comprises silica the tether may be attached by means of a Si—O—Si bond. Where the functionalising material only partially covers the (TIR) surface or interface parts of the surface which are not fully covered can become charged, and can act as an affinity surface, and by controlling the surface coverage the charged properties of the surface/interface can be modified.

Where a protein or a monoclonal (or polyclonal) antibody is used as the functionalising material, there may be a natural chromophore or a chromophore may be tethered to the protein or antibody to allow it to be seen at the operating wavelengths of the sensor. For example an antibody-based oestrogen sensor may be constructed, in embodiments for real time monitoring, say in a river. An antibody may be deposited by many known techniques.

In some preferred arrangements the sensing device comprises a fibre optic (FO) cable. This facilitates practical applications of the technology, in particular outside a lab environment, and the fabrication of inexpensive or even disposable sensing devices, for example for pregnancy or sugar tests. The modification may comprise removing a portion of the FO surface and/or tapering the FO; by controlling the degree of modification/taper the evanescent field may also be controlled and hence adapted to a particular sensing function or application.

We also describe herein a sensor for a cavity of an evanescent-wave cavity ring down device, the sensor comprising a fibre optic cable having a core configured to guide light down the fibre surrounded by an outer cladding of lower refractive index than the core, wherein a sensing portion of the fibre optic cable is configured have a reduced thickness cladding provided with a functionalising material which has a selective response to a target such that an evanescent wave from said guided light interacts with said material and is modified by the presence of said target.

We also describe herein an optical cavity-based sensing device comprising: an optical cavity absorption sensor comprising an optical cavity formed by a pair of reflecting surfaces; a light source for providing light to couple into said cavity; and a light detector for detecting a level of light escaping from said cavity; wherein said optical cavity includes a sensing device comprising a functionalised optical interface, said optical interface being provided with a material which has a selective response to a target.

We also describe herein an optical cavity-based gas-phase sensing device comprising: an optical cavity absorption sensor comprising an optical cavity formed by a pair of reflecting surfaces; a light source for providing light to couple into said cavity; and a light detector for detecting a level of light escaping from said cavity; wherein said optical cavity includes a sensing device comprising a functionalised optical interface, said optical interface being provided with a solvating medium to convert a gas-phase target to a solution at said interface.

We also describe herein an evanescent wave optical sensing device, the device having a light input and a light output and being configured to provide an optical path between said light input and said light output, said optical path including a totally internally reflecting (TIR) optical interface for attenuated TIR-based sensing, and wherein said TIR interface is provided with a functionalising material which has a selective response to a target such that an evanescent wave at said interface is modified by the presence of said target.

Depending upon the absorbance only one or two passes may be necessary to provide a detectable signal; in embodiments the light input and light output may substantially correspond.

We also describe herein a method of refreshing an interface to which is attached a material which has a selective response to a target, the method comprising: providing said interface with a photoelectron generator; and illuminating said photoelectron generator to release electrons to refresh said interface.

Similarly the invention provides a sensing device including an interface to which is attached a material which has a selective response to a target, and wherein said interface is further provided with a photoelectron generator to assist in refreshing said interface.

The photoelectron generator may comprise a metallic material or metal oxide such as titanium (di)oxide or a (semi)conducting polymer or biopolymer.

Further features and advantages of some implementations of the above described systems will now be described. These have previously been set out in detail in the Applicant's co-pending International patent application number PCT/GB2004/000020, filed on 8 Jan. 2004, the entire contents of which are hereby incorporated by reference.

The sensitivity of an e-CRDS or a conventional CRDS-based device may be improved by taking a succession of measurements and averaging the results. However the frequency at which such a succession of measurements can be made is limited by the maximum pulse rate of the pulsed laser employed for injecting light into the cavity. This limitation can be addressed by employing a continuous wave (CW) laser such as a laser diode, since such lasers can be switched on and off faster than a pulsed laser's maximum pulse repetition rate. However, there are significant difficulties associated with coupling light from a CW laser into the cavity, particularly where a so-called stable cavity is employed, typically comprising planar or concave mirrors.

We have previously described, in UK patent application no. 0302174.8, how these difficulties may be addressed by employing a cavity ring-down sensor with a light source, such as a continuous wave laser, of a power and bandwidth sufficient to overcome losses within the cavity and couple energy into at least two modes of oscillation (either transverse or longitudinal) of the cavity. Preferably the light source is operable as a substantially continuous source and has a bandwidth sufficient to provide at least a half maximum power output across a range of frequencies equal to at least a free spectral range of the cavity. This facilitates coupling of light into the cavity even when modes of the light source and cavity are not exactly aligned. The light source may be shuttered or electronically controlled so that the excitation may be cut off to allow measurement of a ring-down decay curve. To facilitate accurate measurement of a ring-down time the CW light source output is preferably cut off in less than 100 ns, more preferably less than 50 ns. When driven with a CW laser the cavity preferably has a length of greater than 0.5 m more preferably greater than 11.0 m because a longer cavity results in closer spaced longitudinal modes.

In general the evanescent wave may either sense a substance directly or may mediate a sensing interaction through sensing a substance or a property of a material. The detector detects a change in light level in the cavity resulting from absorption of the evanescent wave, and whilst in practice this is almost always performed by measuring a ring-down characteristic of the cavity, in principle a ring-up characteristic of a cavity could additionally or alternatively be monitored. As the skilled person will appreciate the reflecting surfaces of the cavity are optical surfaces generally characterized by a change in reflective index, and may physically comprise internal or external surfaces.

The number of passes light makes through the cavity depends upon the Q of the cavity which, for most (but not all) applications, should be as high as possible. Although the cavity ring-down is responsive to absorption in the cavity this absorption may either be direct absorption by a sensed material or may be a consequence of some other physical effect, for example surface plasmon resonance (SPR) or measured property.

We have also previously described, in UK patent application no. 0302174.8, how in a preferred embodiment the cavity comprises a fibre optic cable with reflective ends. In embodiments this provides a number of advantages including physical and optical robustness, physically small size, durability, ease of manufacture, and flexibility, enabling use of such a sensor in a wide range of non lab-based applications.

To provide an evanescent-wave sensor a fibre optic cable may be modified to provide access to an evanescent field of light guided within the cable. The invention provides a fibre-optic sensor of this sort, for example for use in evanescent wave cavity ring-down device of the general type described above.

A fibre optic cable typically comprises a core configured to guide light down the fibre surrounded by an outer cladding of lower refractive index than the core. A sensing portion of the fibre optic cable may be configured have a reduced thickness cladding over part or all of the circumference of the fibre such that an evanescent wave from said guided light is accessible for sensing. By reducing the thickness of the cladding, in embodiments to expose the core, the evanescent wave can interact directly with a sensed material or substance or attenuation of light within the cavity via absorption of the evanescent wave can be indirectly modified, for example in an SPR-based sensor by modifying the interaction of a surface plasmon excited in overlying conductive material with the evanescent wave (a shift or modification of a plasmon resonance changing the absorption).

One, or preferably both ends of the fibre optic cable may be provided with a highly reflecting surface such as a Bragg stack. The fibre optic cable thus provides a stable cavity, that is guided light confined within the cable will retrace its path many times. Preferably the fibre optic cable (and hence cavity) has a length of at least a length of 0.5 m, and more preferably of at least 10 m, to facilitate coupling of a continuous wave laser to the fibre optic sensor, as described above. The sensor may be coupled to a fibre optic extension and, optionally, may include an optical fibre amplifier; such an amplifier may be incorporated within the cavity.

The fibre optic cable is preferably a step index fibre, although a graded index fibre may also be used, and may comprise a single mode or polarization-maintaining or high birefringence fibre. Preferably the sensing portion of the cable has a loss of less than 1%, more preferably less than 0.5%, most preferably less than 0.25%, so that the cavity has a relatively high Q and consequently a high sensitivity. Where the sensor is to be used in a liquid the core of the fibre should have a greater refractive index than that of the liquid in which it is to be immersed in order to restrict losses from the cavity. The sensor may be attached to a Y-coupling device to facilitate single-ended use, for example inside a human or animal body.

The skilled person will understand that features and aspects of the above described sensors and apparatus may be combined.

In all the above aspects of the invention references to optical components and to light includes components for and light of non-visible wavelengths such as infrared and other light.

These and other aspects of the present invention will now be further described, by way of example only, with reference to the accompanying figures:

FIGS. 1a-1f show, respectively, an operating principle of a CRDS-type system, an operating principle of an e-CRDS-type system, a block diagram of a continuous wave e-CRDS system, and first, second and third total internal reflection devices for a CW e-CRDS system;

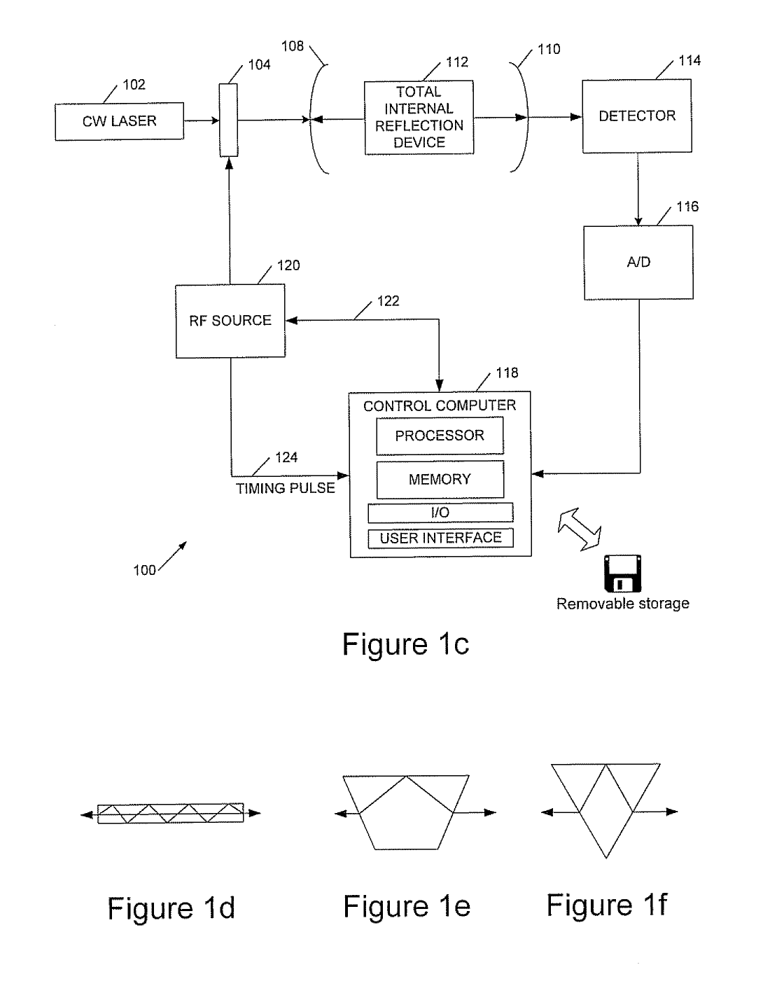

FIG. 2 shows a flow diagram illustrating operation of the system of FIG. 1c;

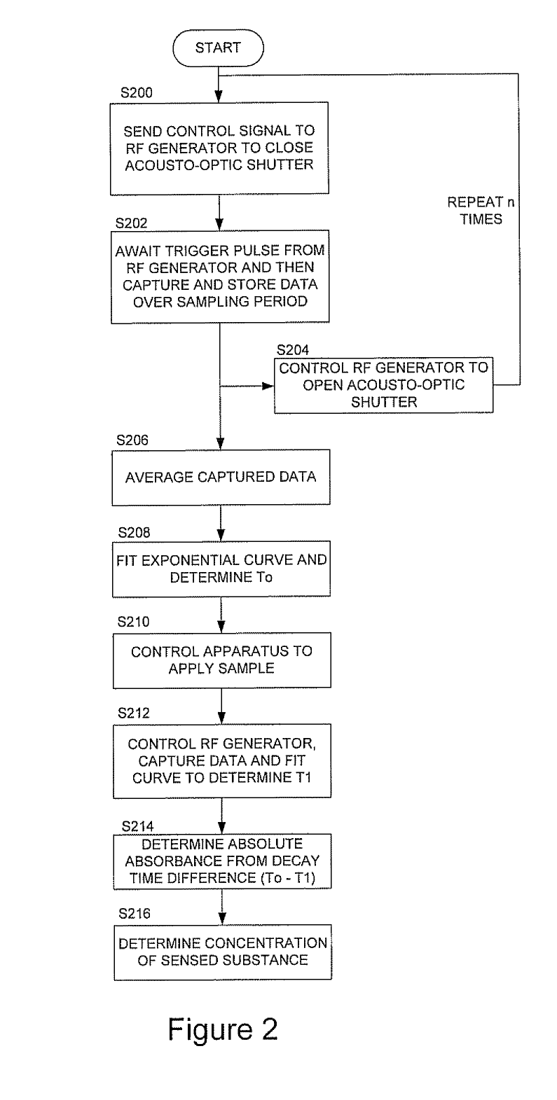

FIGS. 3a-3c show, respectively, cavity oscillation modes for the system of FIG. 1c, a first spectrum of a CW laser for use with the system of FIG. 1c, and a second CW laser spectrum for use with the system of FIG. 1c;

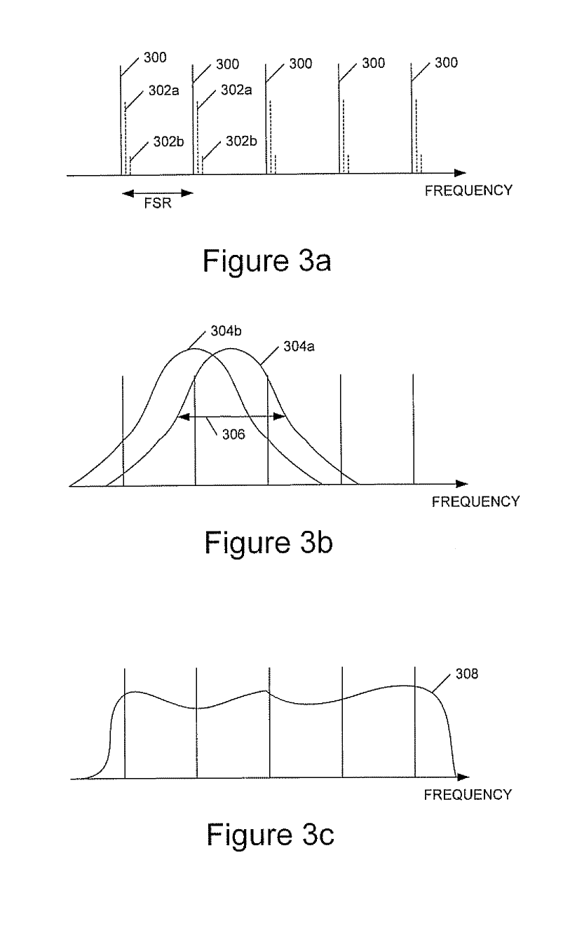

FIGS. 4a-4f show, respectively, a fibre optic-based e-CRDS system, a fibre optic cable for the system of FIG. 4a, an illustration of the effect of polarization in a total internal reflection device, a fibre optic cavity-based sensor, and examples of fibre optic cavity ring-down profiles;

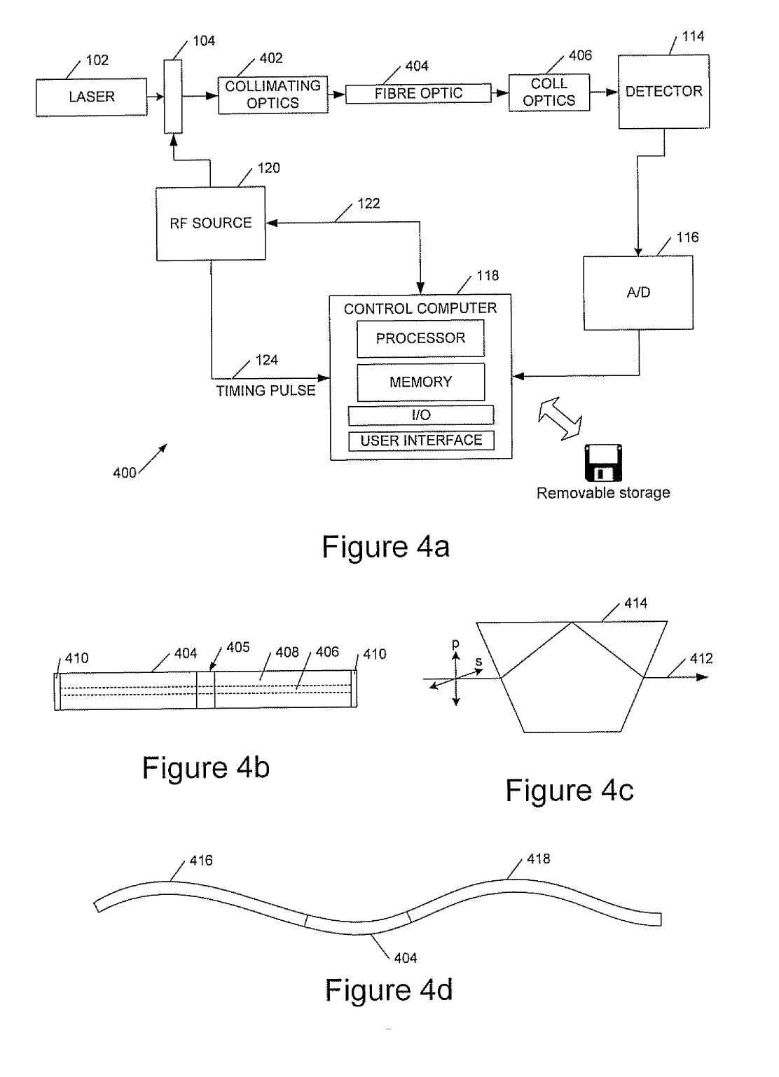

FIGS. 5a and 5b show, respectively, a second fibre optic based e-CRDS device, and a variant of this device;

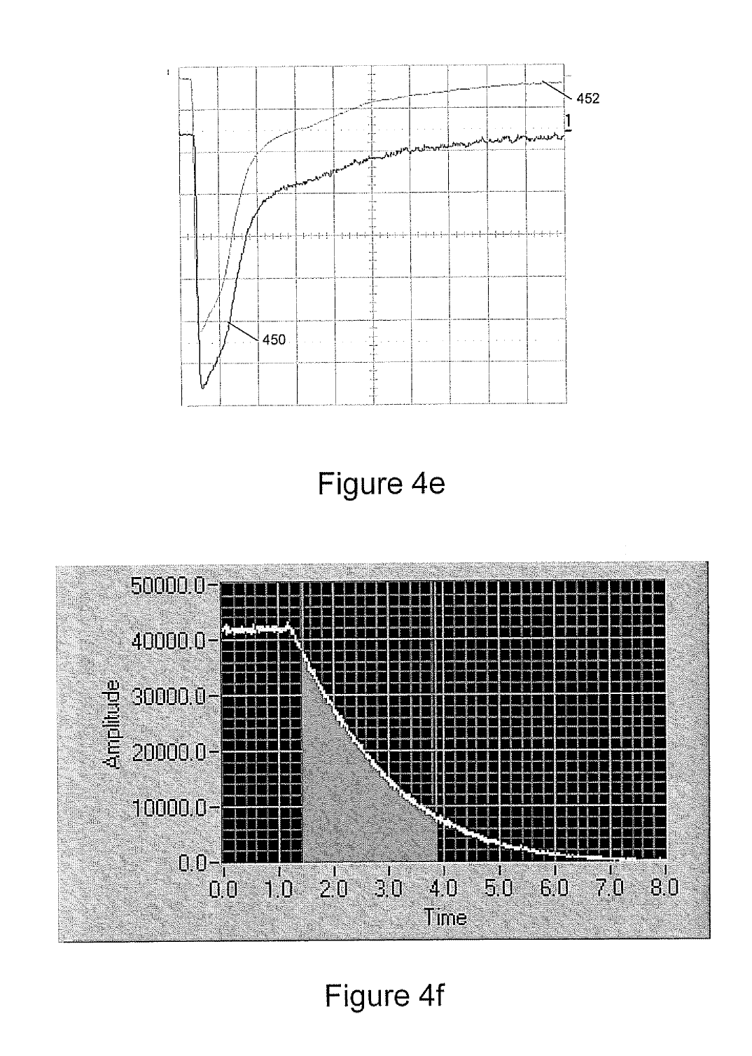

FIGS. 6a and 6b show, respectively, a cross sectional view and a view from above of a sensor portion of a fibre optic cavity;

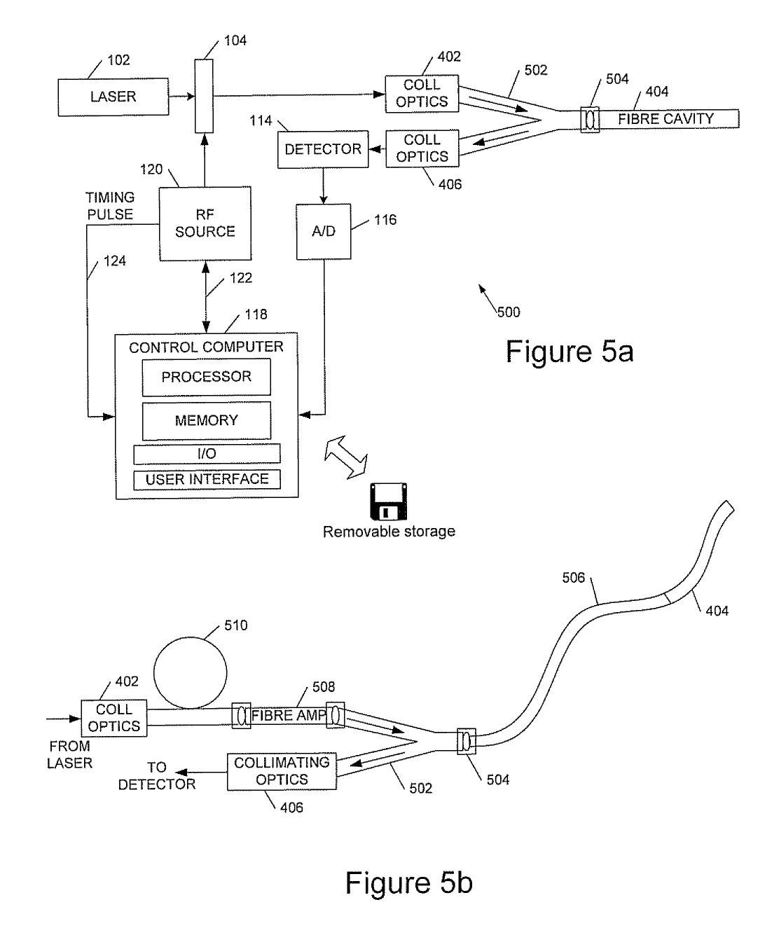

FIGS. 7a and 7b show, respectively, a procedure for forming the sensor portion of FIG. 6, and a detected light intensity-time graph associated with the procedure of FIG. 7a;

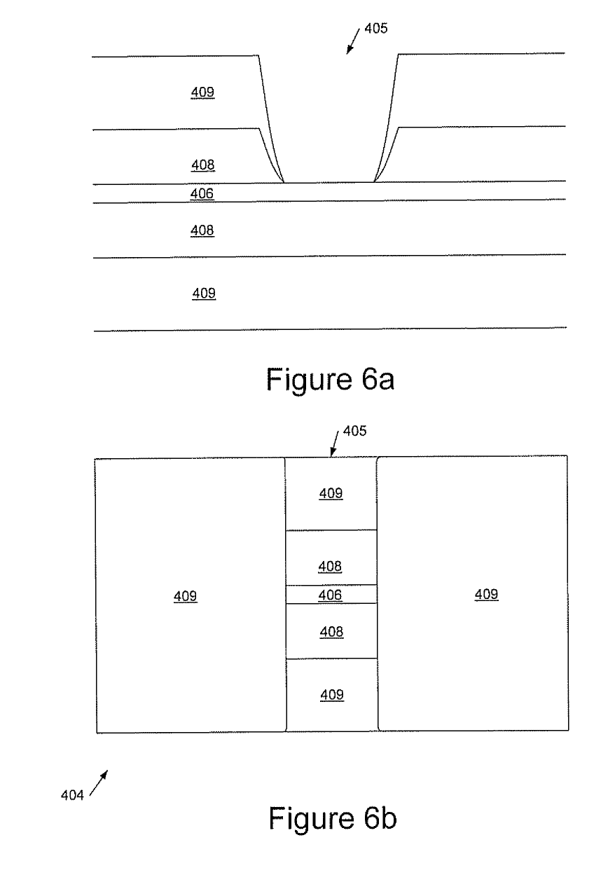

FIG. 8 shows an example of an application of an e-CRDS-based fibre optic sensor;

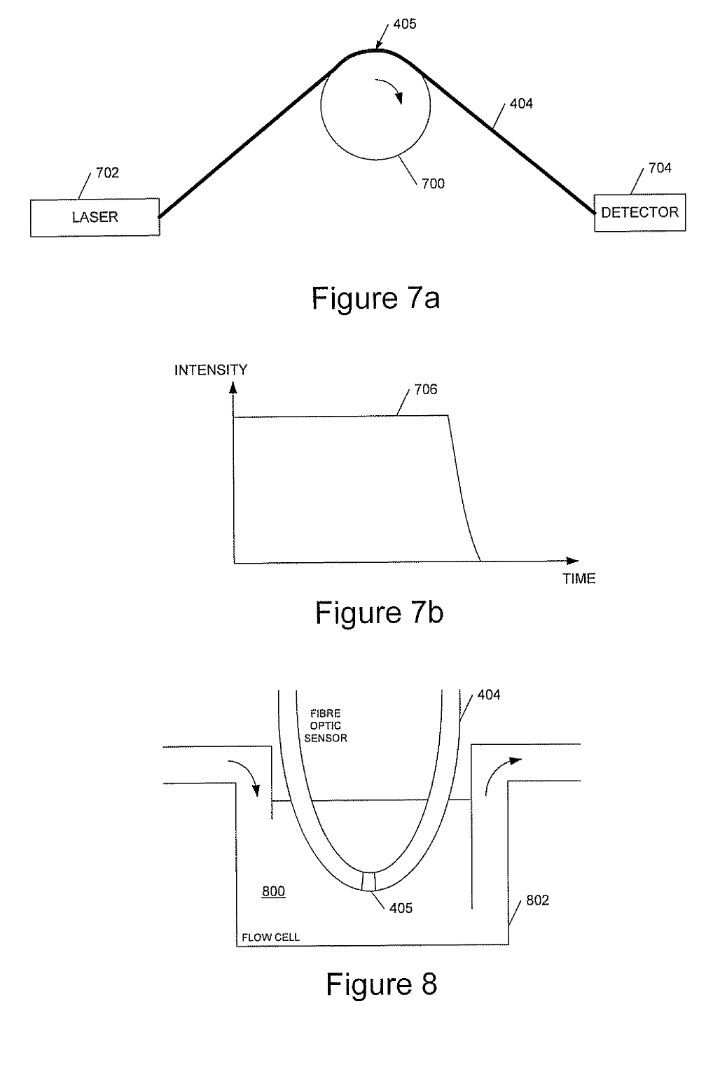

FIG. 9 shows synthesis of a Nile Blue derivative;

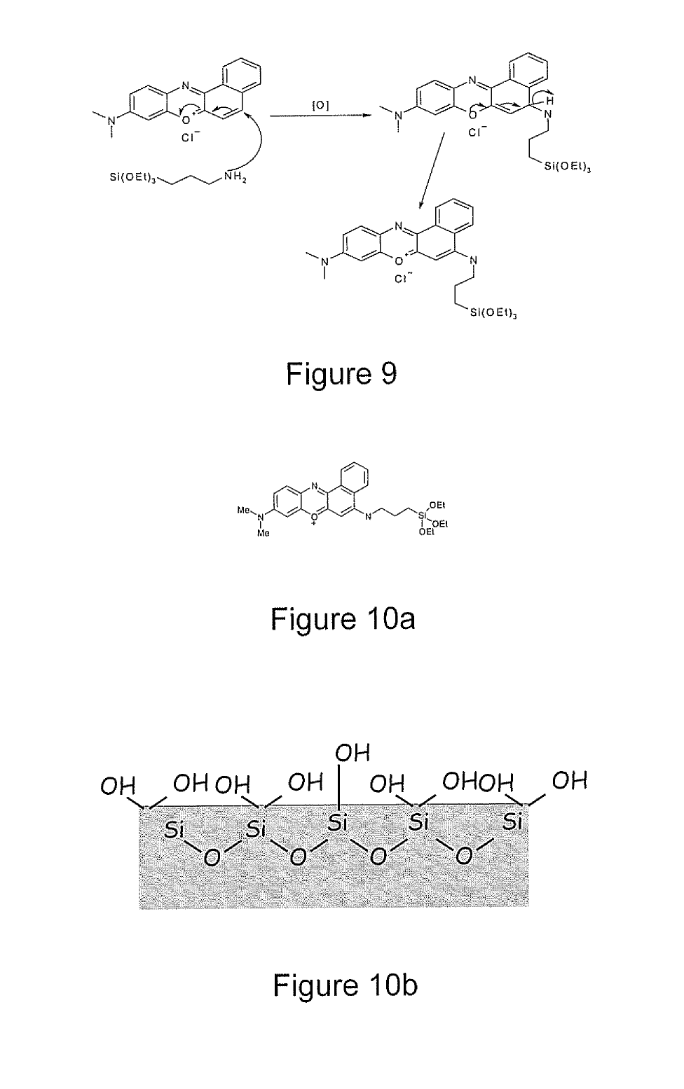

FIGS. 10a to 10c show, respectively, a silyl functionalised Nile Blue derivative, a silica/water interface, and a schematic diagram of a chrompohore attached to a sensor surface to provide a pH sensor;

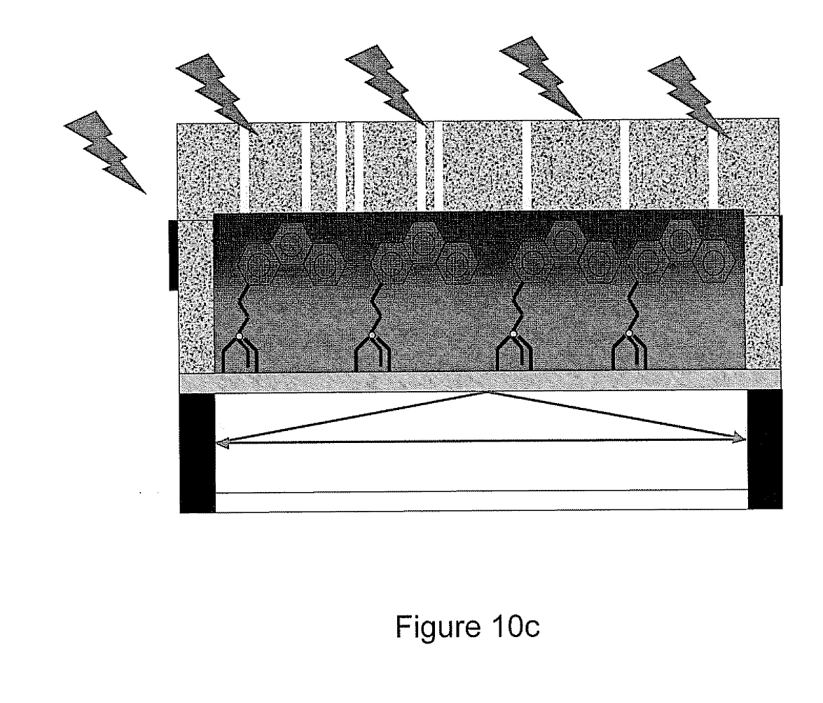

FIG. 11a and 11b show examples of actually constructed apparatus embodying aspects of the present invention;

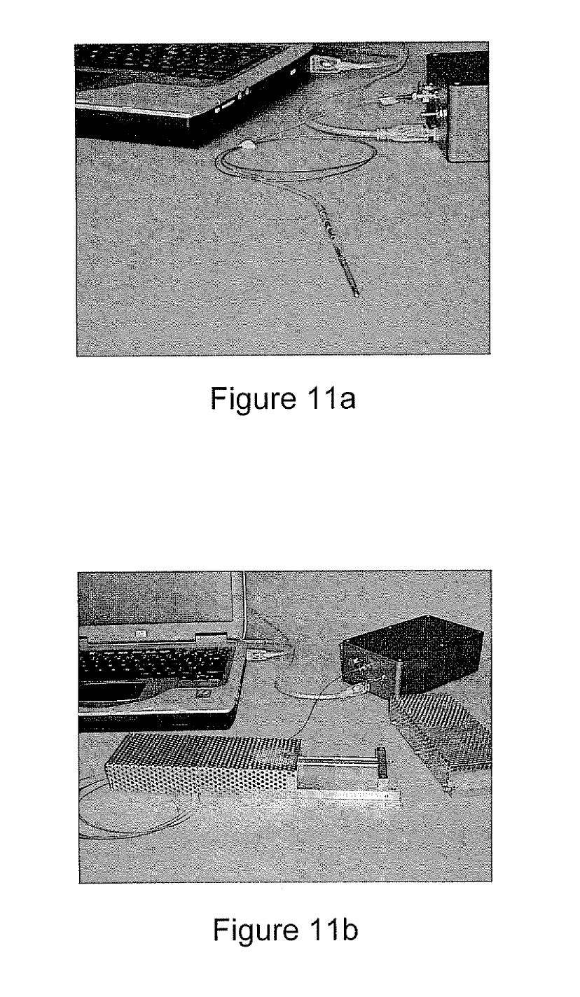

FIGS. 12a and 12b show, respectively, chlorine target level time series data from a crystal violet-based evanescent wave optical sensor, an attack profile for the data of FIG. 12a; and

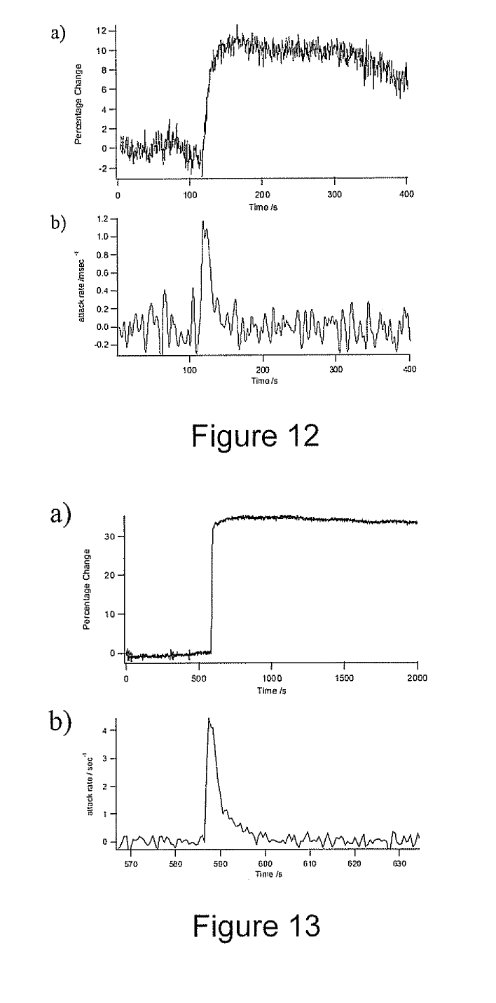

FIGS. 13a and 13b show, respectively, a response for an o-tolidine based chlorine sensor, and attack profile for the response of FIG. 13a.

We will first describe details of some particular preferred examples of e-CRDS-based sensing apparatus and will then, with particular reference to FIG. 9 onwards, describe techniques and improvements embodying aspects of the present invention.

Referring now to FIG. 1c, this shows an example of an e-CRDS-based system 100, in which light is injected into the cavity using a continuous wave (CW) laser 102. In the apparatus 100 of FIG. 1c the ring-down cavity comprises high reflectivity mirrors 108, 110 and includes a total internal reflection device 112. Mirrors 108 and 110 may be purchased from Layertec, Ernst-Abbe-Weg 1, D-99441, Mellingen, Germany. In practice the tunability of the system may be determined by the wavelength range over which the mirrors provide an adequately high reflectivity. Light is provided to the cavity by laser 102 through the rear of mirror 108 via an acousto-optic (AO) modulator 104 to control the injection of light. In one embodiment the output of laser 102 is coupled into an optical fibre and then focused onto a AO modulator 104 with 100 micron spot, the output from AOM 104 then can be collected by a further fibre optic before being introduced into the cavity resonator. This arrangement facilitates chop times of the order of 50 ns, such fast chop times being desirable because of the relatively low finesse of the cavity resonator.

Laser 102 may comprise, for example, a CW ring dye laser operating at a wavelength of approximately 630 nm or some other CW light source, such as a light emitting diode may be employed. For reasons which will be explained further below, the bandwidth of laser (or other light source) 102 should be greater than one free spectral range of the cavity formed by mirrors 108,110 and in one dye laser-based embodiment laser 102 has a bandwidth of approximately 5 GHz. A suitable dye laser is the Coherent 899-01 ring-dye laser, available from Coherent Inc, California, USA. Use of a laser with a large bandwidth excites a plurality of modes of oscillation of the ring-down cavity and thus enables the cavity be “free running”, that is the laser cavity and the ring-down cavity need not rely on positional feedback to control cavity length to lock modes of the two cavities together. The sensitivity of the apparatus scales with the square root of the chopping rate and employing a continuous wave laser with a bandwidth sufficient to overlap multiple cavity modes facilitates a rapid chop rate, potentially at greater than 100 KHz or even greater than 1 MHz.

A radio frequency source 120 drives AO modulator 104 to allow the CW optical drive to cavity 108, 110 to be abruptly switched off (in effect the AO modulator acts as a controllable diffraction grating to steer the beam from laser 102 into or away from cavity 108, 100). A typical cavity ring-down time is of the order of a few hundred nanoseconds and therefore, in order to detect light from a significant number of bounces in the cavity, the CW laser light should be switched off in less than 100 ns, and preferably in less than about 30 ns. Data collected during this initial 100 ns period, that is data from an initial portion of the ring-down before the laser has completely stopped injecting light into the cavity, is generally discarded. To achieve such a fast switch-off time with the above mentioned dye laser an AO modulator such as the LM250 from Isle Optics, UK, may be used in conjunction with a RF generator such as the MD250 from the same company.

The RF source 120 and, indirectly, the AO modulator 104, is controlled by a control computer 118 via an IEEE bus 122. The RF source 120 also provides a timing pulse output 124 to the control computer to indicate when light from laser 102 is cut off from the cavity 108-110. It will be recognized that the timing edge of the timing pulse should have a rise or fall time comparable with or preferably faster than optical injection shut-off time.

Use of a tunable light source such as a dye laser has advantages for some applications but in other applications a less tunable CW light source, such as a solid state diode laser may be employed, again in embodiments operating at approximately 630 nm. It has been found that a diode laser may be switched off in around 10 ns by controlling the electrical supply to the laser, thus providing a simpler and cheaper alternative to a dye laser for many applications. In such an embodiment RF source 120 is replaced by a diode laser driver which drives laser 102 directly, and AO modulator 104 may be dispensed with. An example of a suitable diode laser is the PPMT LD1338-F2, from Laser 2000 Ltd, UK, which includes a suitable driver, and a chop rate for the apparatus, and in particular for this laser, may be provided by a Techstar FG202 (2 MHz) frequency generator.

A small amount of light from the ring-down cavity escapes through the rear of mirror 110 and is monitored by a detector 114, in a preferred embodiment comprises a photo-multiplier tube (PMT) in combination with a suitable driver, optionally followed by a fast amplifier. Suitable devices are the H7732 photosensor module from Hammatsu with a standard power supply of 15V and an (optional) Ortec 9326 fast pre-amplifier. Detector 114 preferably has a rise time response of less than 100 ns more preferably less than 50 ns, most preferably less than 10 ns. Detector 114 drives a fast analogue-to-digital converter 116 which digitizes the output signal from detector 114 and provides a digital output to the control computer 118; in one embodiment an A to D on board a LeCroy waverunner LT 262 350 MHz digital oscilloscope was employed. Control computer 118 may comprise a conventional general purpose computer such as a personal computer with an IEEE bus for communication with the scope or A/D 116 may comprise a card within this computer. Computer 118 also includes input/output circuitry for bus 122 and timing line 124 as well as, in a conventional manner, a processor, memory, non-volatile storage, and a screen and keyboard user interface. The non-volatile storage may comprise a hard or floppy disk or CD-ROM, or programmed memory such as ROM, storing program code as described below. The code may comprise configuration code for LabView (Trade Mark), from National Instruments Corp, USA, or code written in a programming language such as C.

Examples of total internal reflection devices which may be employed for device 112 of FIG. 1c are shown in FIGS. 1d, 1e and 1f. FIG. 1d shows a fibre optic cable-based sensing device, as described in more detail later. FIG. 1e shows a first, Pellin Broca type prism, and FIG. 1f shows a second prism geometry. Prisms of a range of geometries, including Dove prisms, may be employed in the apparatus of FIG. 1c, particularly where an anti-reflection coating has been applied to the prism. The prisms of FIGS. 1e and 1f may be formed from a range of materials including, but not limited to glass, quartz, mica, calcium fluoride, fused silica, and borosilicate glass such as BK7.

Referring now to FIG. 2, this shows a flow diagram of one example of computer program code operating on control computer 118 to control the apparatus of FIG. 1c.

At step S200 control computer 118 sends a control signal to RF source 120 over bus 122 to control radio frequency source 120 to close AO shutter 104 to cut off the excitation of cavity 108-110. Then at step S202, the computer waits for a timing pulse on line 124 to accurately define the moment of cut-off, and once the timing pulse is received digitized light level readings from detector 114 are captured and stored in memory. Data may be captured at rates up to, for example, 1G samples per second (1 sample/ns at either 8 or 16 bit resolution) preferably over a period of at least five decay lifetimes, for example, over a period of approximately 5 is. Computer 118 then controls RF generator to re-open the shutter and the procedure loops back to step S200 to repeat the measurement, thereby capturing a set of cavity ring-down decay curves in memory.

When a continuous wave laser source is used to excite the cavity decay curves may be captured at a relatively high repetition rate. For example, in one embodiment decay curves were captured at a rate of approximately 20 kHz per curve, and in theory it should be possible to capture curves virtually back-to-back making measurements substantially continuously (with a small allowance for cavity ring-up time). Thus, for example, when capturing data over a period of approximately 5 μs it should be possible to repeat measurements at a rate of approximately 20 kHz. The data from the captured decay curves are then averaged at step S206, although in other embodiments other averaging techniques, such as a running average, may be employed.

At step S208 the procedure fits an exponential curve to the averaged captured data and uses this to determine a decay time τ₀ for the cavity in an initial condition, for example when no material to be sensed is present. The decay time τ₀ is the time taken for the light intensity to fall to 1/e of its initial value (e=2.718). Any conventional curve fitting method may be employed; one straight—forward method is to take a natural logarithm of the light intensity data and then to employ a least squares straight line fit. Preferably data at the start and end of the decay curve is omitted when determining the decay time, to reduce inaccuracies arising from the finite switch-off time of the laser and from measurement noise. Thus for example data between 20 percent and 80 percent of an initial maximum may be employed in the curve fitting. Optionally a baseline correction to the captured light intensity may be applied prior to fitting the curve; this correction may be obtained from an initial calibration measurement.

Following this initial decay time measurement computer 118 controls the apparatus to apply a sample (gas, liquid or solid) to the total internal reflection device 112 within the ring-down cavity; alternatively the sample may be applied manually. The procedure then, at step S212, effectively repeats steps S200-S208 for the cavity including the sample, capturing and averaging data for a plurality of ring-down curves and using this averaged data to determine a sample cavity ring-down decay time τ₁. Then, at step S214, the procedure determines an absolute absorption value for the sample using the difference in decay times (τ₀−τ₁) and, at step S216, the concentration of the sensed substance or species can be determined. This is described further below.

In an evanescent wave ring-down system such as that shown in FIG. 1c the total (absolute) absorbance can be determined from Δτ=τ₁−τ₀ using equation 2 below.

$$Abs = \frac{Δ t}{τ {τ}_{0}} ( \frac{{t}_{r}}{2} ) \qquad ( Equation 2 )$$

In equation 2 tᵣ is the round trip time for the cavity, which can be determined from the speed of light and from the optical path length including the total internal reflection device. The molecular concentration can then be determined using equation 3;

Absorbance=εCL (Equation 3)

where ε is the (molecular) extinction co-efficient for the sensed species, C is the concentration of the species in molecules per unit volume and L is the relevant path length, that is the penetration depth of the evanescent wave into the sensed medium, generally of the order of a wavelength. Since the evanescent wave decays away from the total internal reflection interface strictly speaking equation 3 should employ the Laplace transform of the concentration profile with distance from the TIR surface, although in practice physical interface effects may also come into play. A known molecular extinction co-efficient may be employed or, alternatively, a value for an extinction co-efficient for equation 3 may be determined by characterizing a material beforehand.

Referring next to FIG. 3a this shows a graph of frequencies (or equivalently, wavenumber) on the horizontal axis against transmission into a high Q cavity such as cavity 108, 110 of FIG. 1c, on the vertical axis. It can be seen that, broadly speaking, light can only be coupled into the cavity at discrete, equally-spaced frequencies corresponding to allowed longitudinal standing waves within the cavity known as longitudinal cavity modes. The interval between these modes is known as the free spectral range (FSR) of the cavity and is defined as equation 4 below.

FSR=(l/2c′) (Equation 4)

Where l is the length of the cavity and c′ is the effective speed of light within the cavity, that is the speed of light taking into account the effects of a non-unity refractive index for materials within the cavity. For a one-meter cavity, for example, the free spectral range is approximately 150 MHz. Lines 300 in FIG. 3a illustrate successive longitudinal cavity modes. FIG. 3a also shows (not to scale) a set of additional, transverse cavity modes 302a, b associated with each longitudinal mode, although these decay rapidly away from the longitudinal modes. The transverse modes are much more closely spaced than the longitudinal modes since they are determined by the much shorter transverse cavity dimensions. To couple continuous wave radiation into the cavity described by FIG. 3a the light source with sufficient bandwidth to overlap at least too longitudinal cavity modes may be employed. This is shown in FIG. 3b.

FIG. 3b shows FIG. 3a with an intensity (Watts per m²) or equivalently power spectrum 304a, b for a continuous wave laser superimposed. It can be seen that provided the full width at half maximum 306 of the laser output spans at least one FSR laser radiation should continuously fill the cavity, even if the peak of the laser output moves, as shown by spectra 304a and b. In practice the laser output may not have the regular shape illustrated in FIG. 3b and FIG. 3c illustrates, diagrammatically an example of the spectral output 308 of a dye laser which, broadly speaking, comprises a super imposition of a plurality of broad resonances at the cavity modes of the laser.

Referring again to FIG. 3b it can be seen that as the peak of the laser output moves, although two modes are always excited these are not necessarily the same two modes. It is desirable to continuously excite a cavity mode, taking into account shifts in mode position caused by vibration and/or temperature changes and it is therefore preferable that the laser output overlaps more than two modes, for example, five modes (as shown in FIG. 3c) or ten modes. In this way even if mode or laser frequency changes one mode at least is likely to be continuously excited. To cope with large temperature variations a large bandwidth may be needed and for certain designs of instruments, for example, fibre optic-based instruments it is similarly desirable to use a CW laser with a bandwidth of five, ten or more FSRs. For example a CW ring dye laser with a bandwidth of 5 GHz has advantageously employed with a cavity length of approximately one meter and hence an FSR of approximately 150 MHz.

For clarity transverse modes have not been shown in FIG. 3b or FIG. 3c but it will be appreciated light may be coupled into modes with a transverse component as well as a purely longitudinal modes, although to ensure continuous excitation of a cavity it is desirable to overlap at least two different longitudinal modes of the cavity

In order to excite a cavity mode sufficient power must be coupled into the cavity to overcome losses in the cavity so that the mode, in effect rings up. Preferably, however, at least half the maximum laser intensity at its peak frequency is delivered into at least two modes since this facilitates fast repetition of decay curve measurement and also increases sensitivity since decay curves will begin from a higher initial detected intensity. It will be appreciated that when the bandwidth of the CW laser overlaps with longitudinal modes of the ring-down cavity as described above, the power within the cavity depends on the incident power of the exciting laser, which enables the power within the cavity to be controlled, thus facilitating power dependent measurements and sensing.

FIG. 4a shows a fibre optic-based e-CRDS type sensing system 400 similar to that shown in FIG. 1c, in which like elements are indicated by like reference numerals. In FIG. 4a, however, mirrors 108, 110, and total internal reflection device 112 are replaced by fibre optic cable 404, the ends of which have been treated to render them reflective to form a fibre optic cavity. In addition collimating optics 402 are employed to couple light into fibre optic cable 404 and collimating optics 406 are employed to couple light from fibre optic cable 404 into detector 414.

FIG. 4b shows further details of fibre optic cable 404, which, in a conventional manner comprises a central core 406 surrounded by cladding 408 of lower refractive index than the core. Each end of the fibre optic cable 404 is, in the illustrated embodiment polished flat and provided with a multi layer Bragg stack 410 to render it highly reflective at the wavelength of interest. As the skilled person will be aware, a Bragg stack is a stack of quarter wavelength thick layers of materials of alternating refractive indices. To deposit the Bragg stacks the ends of the fibre optic cable are first prepared by etching away the surface and then polishing the etched surface flat to within, for example, a tenth of a wavelength (this polishing criteria is a commonly adopted standard for high-precision optical surfaces). Bragg stacks may then be deposited by ion sputtering of metal oxides; such a service is offered by a range of companies including the above-mentioned Layertec, Gmbh. Fibre optic cable 404 includes a sensor portion 405, as described further below.

Preferably optical fibre 404 is a single mode step index fibre, advantageously a single mode polarization preserving fibre to facilitate polarization-dependent measurements and to facilitate enhancement of the evanescent wave field. Such enhancement can be understood with reference to FIG. 4c which shows total internal reflection of light 412 at a surface 414. It can be seen from inspection of FIG. 4c that p-polarized light (within the plane containing light 412 and the normal to surface 414) generates an evanescent wave which penetrates further from surface 414 than does s-polarized light (perpendicular to the plane containing light 412 and the normal to surface 414).

The fibre optic cable is preferably selected for operation at a wavelength or wavelengths of laser 102. Thus, for example, where laser 102 operates in the region of 630 nm so called short-wavelength fibre may be employed, such as fibre from INO at 2470 Einstein Street, Sainte-Foy, Quebec, Canada. Broadly speaking suitable fibre optic cables are available over a wide range of wavelengths from less than 500 nm to greater than 1500 nm. Preferably low loss fibre is employed. In one embodiment single mode fibre (F601A from INO) with a core diameter of 5.6 μm (a cut-off at 540 nm, numerical aperture of 0.11, and outside diameter of 125 μm) and a loss of 7 dB/km was employed at 633 nm, giving a decay time of approximately 1.5 μs with a one meter cavity and an end reflectivity of R=0.999. In general the decay time is given by equation 5 below where the symbols have their previous meanings, f is the loss in the fibre (units of m⁻¹ i.e. percentage loss per metre) and l is the length of the fibre in metres.

Δτ=tᵣ/{2(1−R)+fl} (Equation 5)

FIG. 4d illustrates a simple example of an alternative configuration of the apparatus of FIG. 4a, in which fibre optic cavity 404 is incorporated between two additional lengths of fibre optic cable 416, 418, light being injected at one end of fibre optic cable 416 and recovered from fibre optic cable 418, which provides an input to detector 114. Fibre optic cables 414, 416 and 418 may be joined in any conventional manner, for example using a standard FC/PC—type connector.

FIGS. 4e and 4f show examples of cavity ring-down decay curves obtained with apparatus similar to that shown in FIG. 4a with a cavity of length approximately one meter and the above mentioned single mode fibre. FIG. 4e shows two sampling oscilloscope traces captured at 500 mega samples per second with a horizontal (time) grid division of 0.2 μs and a vertical grid division of 50 μV. Curve 450 represents a single measurement and curve 452 and average of nine decay curve measurements (in FIG. 4e the curve has been displaced vertically for clarity) the decay time for the averaged decay curve 452 was determined to be approximately 1.7 μs. The slight departure from an exponential shape (a slight kink in the curve) during the initial approximately 100 ns is a consequence of coupling of radiation into the cladding of the fibre, which is rapidly attenuated by the fibre properties and losses to the surroundings.

Referring now to FIG. 5a this shows a variant of the apparatus of FIG. 4a, again in which like elements are indicated by like reference numerals. In FIG. 5a a single-ended connection is made to fibre cavity 404 although, as before, both ends of fibre 404 are provided with highly reflecting surfaces. Thus in FIG. 5a a conventional Y-type fibre optic coupler 502 is attached to one end of fibre cavity 404, in the illustrated example by an FC/PC screw connector 504. The Y connector 502 has one arm connected to collimating optics 402 and its second arm connecting to collimating optics 406. To allow laser light to be launched into fibre cavity 404 and light escaping from fibre cavity 404 to be detected from a single end of the cavity. This facilitates use of a fibre cavity-based sensor (such as is described in more detail below) in many applications, in particular applications where access both ends of the fibre is difficult or undesirable. Such applications include intra-venous sensing within a human or animal body and sensing within an oil well bore hole.

FIG. 5b shows a variant in which fibre cavity 404 is coupled to Y-connector 502 via an intermediate length of fibre optic cable 506 (which again may be coupled to cable 504 via a FC/PC connector). FIG. 5b also illustrates the use of an optional optical fibre amplifier 508 such as an erbium-doped fibre amplifier. In the illustrated example fibre amplifier 508 is acting as a relay amplifier to boost the output of collimating optics 402 after a long run through a fibre optic cable loop 510. (For clarity in FIG. 5b the pump laser for fibre amplifier 508 is not shown). The skilled person will appreciate that many other configurations are possible. For example provided that the fibre amplifier is relatively linear it may be inserted between Y coupler 502 and collimating optics 506 without great distortion of the decay curve. Generally speaking, however, it is preferable that detector 114 is relatively physically close to the output arm of Y coupler 512, that is preferably no more than a few centimeters from the output of this coupler to reduce losses where practically possible; alternatively a fibre amplifier may be incorporated within cavity 404. In further variants of the arrangement of figures multiple fibre optic sensors may be employed, for example by splitting the shuttered output of laser 102 and capturing data from a plurality of detectors, one for each sensor. Alternatively laser 102, shutter 104, and detector 114 may be multiplexed between a plurality of sensors in a rotation.

To utilize the fibre optic cavity 404 as a sensor of an e-CRDS based instrument access to an evanescent wave guided within the fibre is needed. FIGS. 6a and 6b show one way in which such access may be provided. Broadly speaking a portion of cladding is removed from a short length of the fibre to expose the core or more particularly to allow access to the evanescent wave of light guided in the core by, for example, a substance to be sensed.

FIG. 6a shows a longitudinal cross section through a sensor portion 405 of the fibre optic cable 404 and FIG. 6b shows a view from above of a part of the length of fibre optic cable 404 again showing sensor portion 405. As previously explained the fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen from FIG. 6 at the sensor portion of the cable the cladding 408 is at least partially removed to expose the core and hence to permit access to the evanescent wave from guided light within the core. The thickness of the cladding is typically 100 μm or more, but the cladding need not be entirely removed although preferably less than 10 μm thickness cladding is left at the sensor portion of the cable. It will be appreciated that there is no specific restriction on the length of the sensor portion although it should be short enough to ensure that losses are kept well under one percent. It will be recognized that, if desired, multiple sensor portions may be provided on a single cable.

A sensor portion 405 on a fibre optic cable may be created either by mechanical removal of the casing 409 and portion of the cladding 408 or by chemical etching. FIGS. 7a and 7b demonstrate a mechanical removal process in which the fibre optic cable is passed over a rotating grinding wheel (with a relatively fine grain) which, over a period of some minutes, mechanically removes the casing 409 and cladding 408. The point at which the core 406 is optically exposed may be monitored using a laser 702 injecting light into the cable which is guided to a detector 704 where the received intensity is monitored. Refractive index matching fluid (not shown in FIG. 7a) is provided at the contact point between grinding wheel 700 and table 404, this fluid having a higher refractive index than the core 406 so that when the core is exposed light is coupled out of the core and the detected intensity falls to zero.

FIG. 7b shows a graph of light intensity received by detector 704 against time, showing a rapid fall in received intensity at point 706 as the core begins to be optically exposed so that energy from the evanescent wave can couple into the index matching fluid and hence out of the table. With a chemical etching process a similar procedure may be employed to check when the evanescent wave is accessible, that is when the core is being exposed, by removing the fibre from the chemical etch ant at intervals and checking light propagation through the fibre when index matching fluid is applied at the sensor portion of the fibre. An example of a suitable enchant is hydrofluoric acid (HF).

FIG. 8 shows a simple example of an application of the apparatus of FIG. 4a. Fibre optic cable 404 and sensor 405 are immersed in a flow cell 802 through which is passed an aqueous solution containing a chromophore whose absorbance is responsive to a property to be measured such as pH. Using the apparatus of FIG. 4a at a wavelength corresponding to an absorption band of the chromophore very small changes, in this example pH, may be measured.

The above described instruments may be used for gas, liquid and solid phase measurements although they are particularly suitable for liquid and solid phase materials. Instruments of the type described, particularly those of the type shown in FIG. 1c may operate at any of a wide range of wavelengths or at multiple wavelengths. For example optical high reflectivity are mirrors available over the range 200 nm-20 μm and suitable light sources include Ti:sapphire lasers for the region 600 nm-1000 nm and, at the extremes of the frequency range, synchrotron sources. Instruments of the type shown in FIG. 4a may also operate at any of a wide range of wavelengths provided that suitable fibre optic cable is available.

Useful properties for a sensor system include specificity to a target, sensitivity to detect the target and stability, for example to facilitate real-time monitoring. Enzymes in the body, for example, are able to tell the difference between glucose and sucrose and this selectivity can be harnessed as the primary recognition event in chemical sensing, for example for monitoring blood and urine sugar levels, by attaching an enzyme to a sensing surface. The specificity of the DNA and RNA base pair interactions make the detection of a specific sequence possible. An example is mRNA found in eukaryotes and is terminated with the base sequence -AAAAA on the tail. Mounting a -TTTTT sequence gives the right binding for the A-T base pair and would attach the mRNA to the sensor surface. This may then be varied to produce a DNA or RNA specific sequence detector that might be used, for example, in the detection of DNA labels used in anticounterfeiting work.

Biological recognition processes can be based around the specific interactions of immunoglobins or antibodies, with target proteins or antigens. These interactions can either have broad specificity and respond to many similar molecules (polyclonal) or can be highly specific responding, for example, to one type of virus or bacterium from a mixture of similar strains (monoclonal). As previously mentioned this immunochemistry may be applied to the surface of a sensor. Hundreds of antibodies are commercially available raised specifically to antigens, as diverse as heavy metals, anthrax, salmonella, insulin and E. coli for example, and can be used to make a large number of different biosensors.

The “biophotonic” (evanescent wave) interface can additionally or alternatively act as an affinity sensor attracting target molecules to detection sites on the surface of the sensor—for example with a silica interface a positively charged molecule can be attracted to the negatively charged surface. The silica surface is intrinsically negatively charged when placed in water and can be changed to suite the character of the target molecule. For example the surface can be neutralised with passivating agents such as trimethoxymethylsilanes (TMMS) to make the sensor surface hydrophobic and inhibit affinity binding. Alternatively bonding a TMMS, functionalised with a positive group, to the surface makes the silica surface positively charged and can attract negatively charged molecules.

The sensor can respond to direct absorption of light by a target, for example to probe the interface structure, or a chromophore can be tethered to or deposited on an evanescent wave sensing surface.

Implementation of evanescent wave cavity ring-down spectroscopy (e-CRDS) on an optical bench has been achieved by the simple configuration incorporating a Dove prism into a linear cavity (see, for example, A. M. Shaw, T. E. Hannon, F. Li and R. N. Zare J. Phys. Chem.B 107, (2003) 7070.17). The use of a broadband laser light source has enabled the free-running cavity configuration to be used and developed for the liquid phase studies as described above. Measurements on the acid/base characteristics of the silanol groups on the silica surface of the Dove Prism have shown a population of two Si—OH groups: 19% have a pKa ˜4.5 and the remainder has a pKa ˜8.5. The silanol group density is 4 nm⁻². Studies of the absorption isotherm of the charged chromophore Crystal Violet have shown features associated with the evolution of the charged bilayer structure next to the interface and the transition from a diffuse layer to a bilayer or Stern layer structure. The chromophore is attracted to the charged interface within the evanescent field.

The silanol groups can also act as anchoring points for chromophore molecules that may be tethered to the interface. This allows the silica surface to be functionalised with the tethered molecule acting as a host for a target guest species. When the guest species or ligand has bound to the chromophore it changes colour, the absorbance changes and this is detected with the e-CRDS technology. The broadband nature of the laser light source in the above described free-running cavity configuration is well suited to these solution phase optical properties.

Tethering a molecule to the interface can be used to generate a smart surface or chemo-photonic surface as the basis of a detection sensor technology. For a particular application the length of the tether, the deposition rate of the chromophore onto the surface, and the surface coverage of the chromophore at the surface are preferably selected, for example by routine experiment, to be within the loss budget of the e-CRSD cavity. Details are presented here of the tethered chromophore investigations with a specific demonstration of a pH sensor.

Initial experiments synthesised a tether onto Nile Blue chromophore that absorbs at 637 nm, the wavelength of the laser. The modified molecule was then bound to the prepared silica surface and the absorbance change as a proton binds to the molecule is monitored by e-CRDS. Preferably the tether should have little effect on the chromophore's optical or binding specificity properties.

To synthesise a tether Nile Blue, (0.2 g, 0.64 mmol) and

3-aminopropyltriethoxysilane, (0.14 g, 0.64 mmol), were refluxed in methanol solution (30 cm³) for 3 hrs. The resultant solution was increased in volume to 60 cm³ by the addition of more methanol. The resultant solution was washed with hexane and chloroform until the washings became colourless. The solvent was removed in vacuo and the resultant solid dried under vacuum. A ¹H NMR spectrum was obtained and the derivative characterised fully according to standard organic synthesis practice. The synthesis yields tend to be in the range 10-20%. A higher yield can be obtained using a large excess of 3-aminopropyltriethoxysilane, and obtaining the product by precipitation following the addition of excess THF. However, the product tends to polymerise. A reaction scheme for the tether bonding reaction is shown in FIG. 9, which shows synthesis of a Nile Blue derivative.

The resulting characterised species for tethering to the silica surface is shown in FIG. 10a, which shows a silyl functionalised Nile Blue derivative. FIGS. 10b and 10c show, respectively, a silica/water interface and a schematic diagram of a chrompohore attached to a sensor surface to provide a pH sensor. The tether shows a triethoxysilane group that forms a Si—O—Si bond at the surface to bind the species to the surface. The ethoxy group acts as a leaving group when the silicon undergoes nucleophilic attack by the surface silanol group. The OEt leaving group can be replaced with a chloro group producing a chlorosilane derivative with different tethering properties. The tethering process can be varied to provide 1, 2 or 3-OEt or —Cl on the tethered molecule to establish 1, 2 or 3 anchoring points to the surface or the formation of a cross-linked surface polymer chain.

Further details of sensor surface functionalisation can be found in the applicant's co-pending UK patent application No. 0405823.6 filed 15 Mar. 2004, the contents of which are hereby incorporated by reference.

Evanescent wave coupling to crystal violet has been studied and the results are reported in the applicant's UK patent application No. 0405817.8 filed 15 Mar. 2004, the contents of which are hereby incorporated by reference. The experiments were performed in the presence of crystal-violet 122 μM at pH 8.6 for a tapered fibre optic, these parameters being chosen to maximise the binding of the crystal violet to the (charged) silica surface. The results showed that a taper diameter of 25-30 μm is preferred.

The wavelength can be varied from 400 nm-2 μm in a fibre optic system (limited only by the availability of suitable fibre optics—the wavelength range can be extended in non-fibre optic systems), as long as the absorbance of the chromophore changes at the interrogation wavelength. Taper construction need not be varied with the wavelength used. The chromophore can be synthesised to act as a host for any target molecule. There are many examples of these in the literature although a simple tether may need to be added to the structure of the molecule. However other deposition techniques not requiring a tether may also be employed. For example other deposition techniques not requiring a tether are possible with a support material such as a gel or a mesoporous material which is constructed around the surface but within the evanescent field. This can physically trap the molecules which then change colour in the normal way.

Applications include a dirty bomb sensor, for example for UO₂⁺, a nitric oxide (NO) sensor using dinitroanalines, a sensor based on a crown ether, e.g. for K⁺ and Na⁺ to name but two species that may be detected by crown ethers, heavy metal sensors, for example based on Thiacrown ethers sensitive to Hg and Cd. Chemistry Review 91 (1991) 17211-2085, hereby incorporated by reference in its entirety, provides an extensive list of compounds (in excess of 500) that have been used to detect cations and anions in solution such as H⁺, Mg²⁺, Ca²⁺, Cu²⁺, Ba²⁺ to name but five.

All surfaces in the presence of water will acquire a small layer of organisms that will adapt to the surface conditions. This is a problem when the waste products of metabolism affect the contents of a closed container e.g. hydraulic fluid in a cylinder. Monitoring for bio-fouling may employ the bacterium Streptomyces coelicolor, which conveniently produces a blue chromophore as a secondary metabolite. This enables e-CRDS to monitor the growth and rate of production of the bacterium on a surface. Observations on a living (or dead) biological organism may also have applications in, for example, drug screening.

The technique described herein are not restricted to solution phase detection—a surface gel can convert a gas-phase species to an interface solution. Indeed there can be sufficient water at the interface to solvate a gas phase species of interest. Surface gel example is dialysis tubing with known pore size (a few microns) and photopolymerisation of tripropylene glycol diacrylate by photo-activating at 310 nm with various photo initiators such as a morpholino ketone (BDMB Irgacure IC 369) bisacylphosphine oxide (BAPA Irgacure 819) to control the extent of polmerisation. In embodiments the molecular absorbance properties can be tuned to bring the chromophore into resonance with the exciting wavelength. Increasing the taper diameter of the fibre cavity can ameliorate the saturation of the sensor at high concentrations as reduction in the evanescent field can allow the surface colour change to be much greater before detection by e-CRDS. For intensely absorbing species it can be possible to observe the absorbance with only a single pass, two passes or just a few passes.

In some circumstances there is an advantage in moving to longer wavelengths such as 820 nm or 1.5 μm as this has the potential to reduce propagation losses within a fibre. Light sources are available at high power both at 820 nm and 1.5 μm, products of the telecommunications industry. The fibre transmission losses are generally much lower at 820 nm, ˜2 dB km⁻¹ giving ring down time for a 2 m cavity of 4.1 μs and a round trip transmission of 0.997. Thus loss is still dominated by the fibres at 820 nm and the mirror losses do not need to be better than 0.999. At 1.5 μm the fibre losses are 0.18 dBkm⁻¹ and for a 2 m cavity give a cavity ring down time τ of 14.7 μs with a round trip transmission of 0.9993. Mirror reflectivity now becomes important and a cavity operating at this wavelength would preferably employ a 0.9995 or better mirror specification. At each wavelength the cavity parameters changes and the power and detection characteristics can be balanced by routine experiment. Calculation of the minimum detectable absorbance change suggests that the detection limit at 820 nm will be nearly 4 times better than at 639 nm and at 1.5 μm, some 10 times better than at 639 nm. Hence an 820 nm cavity will have a detection sensitivity of order 2×10⁻⁵. The skilled person will recognise that fibre optic e-CRDS will work within any fibre optic of tolerable transmission loss (of order 8 dB km⁻¹).

A longer wavelength than 639 nm, say ˜800 nm, may be used for example with the previously mentioned “dirty bomb” sensor surface. More generally a functionalising molecule may employ an extended porphyrin structure to tune the molecular electronics into this region of the spectrum. For example a range of expanded porphyrin molecules (e.g. isoamethyrin) bind selectively to actinyl ions, UO₂²⁺, PuO₂²⁺ and NpO₂²⁺ and initiate an abrupt colour change. These molecules absorb strongly at around 820 nm when bound to the ions and have very high extinction coefficients, and should be able to detect sub-ppb concentrations of actinides in real time. In a dirty bomb scenario, the plume of radioactivity will spread over a large area around the initial explosion and the attack profile and the progress of decontamination can be monitored. Any granite building will provide a background radiation count due to trapped radon but the background levels of actinides will be essentially zero. The sensor may be deployed remotely or in a network to monitor decontamination over a long period of time, for both airborne and waterborne contamination.

Liquid phase absorption spectra at 1.5 μm (6666 cm⁻¹) tend to be dominated by overtone absorptions but gas phase absorption occurs at these wavelengths, in particular for CH₄ and CO₂, which may be employed for monitoring submarine environments. In a simple arrangement the target molecule is required to land on the silica surface before detection, but the collision with the surface is directly proportional to the gas phase concentration. Longer wavelength radiation may also be employed with a suitable chromophore. For example, infrared chromophores tuned at 1.5 μm can be designed to allow the much lower transmission losses of silica at this wavelength to be exploited. For gas sensing gas overtone absorptions at 1.5 μm should be detectable within the evanescent field of a tapered cavity and in addition, condensed gases should also be detectable. Also specific molecules may be designed to catch target gases according to the functionalised or smart surface chemical sensor concept.

Multiple wavelength (e.g. wavelength division multiplexed) sensing may be employed. For example haemoglobin may be employed as a functionalising material to detect oxygen, CO, or NO, this having an absorption at 425 nm (due to the ion) and at 830 nm (due to the porphyrin ring).

In embodiments of the above described apparatus the occupancy of the silica absorption sites controls the maximum response or saturation of the sensor surface. The site density for un-prepared silica is of order 4 nm⁻². Complete occupancy of a chromophore has a measurable absorbance given by ρ*σ where ρ is the site density and σ is the absorption cross-section for the chosen chromophore. For example for methyl violet σ is 1.6×10⁻¹⁷ cm² giving a monolayer absorbance of 6.36×10⁻³. The sensitivity of one instrument is 1 part per million so surface coverage of 0.01% is the minimum detectable coverage. This corresponds to 10¹⁰ molecules. However the cross-section for other chromophore molecules can be two orders of magnitude bigger than for methyl violet improving the detection threshold to 10⁸ molecules. For this example the dynamic range for complete coverage corresponds to 10⁴ molecules to saturate the sensor surface. The number of surface sites can be increased by improving control of the surface architecture to build branched functional groups onto the surface, which would allow other molecules to bind to the interface. The e-wave is sensitive to of order 240 nm of the silica (BK7) air interface.

Predicted sensitivity for species such as H⁺, Mg²⁺ and UO₂⁺ is of order parts per trillion or lower based on detecting an absorbance change of 10⁻⁴ and an extinction coefficient of order 10⁶ M⁻¹ cm⁻¹. For example, ioamethyrin has an extinction coefficient of 3.3×10⁵ M⁻¹ cm⁻¹ at 800 nm which drops by 50% on binding to a uranyl complex. As previously mentioned the negative potential of the surface can be tailored for individual affinity sensors, for example based on trimethoxymethyl silanes optionally derivatised so that the chemistry of the derivative can be controlled to change the negative character to positive or neutral. The hydrophobicity/hydrophilicity nature of the surface can also be changed by binding long-chain alkyl substituents to the surface or sugar derivatised compounds. Additionally or alternatively, as described above, tethered chromophores bound to the surface can be used as the absorption site, changing colour on binding. Optionally chromophore synthesis can be initiated at the surface producing the chromophore as a result of a chemical reaction and photochemistry at the surface can then be used to produce a detectable change in the chromophore absorption spectrum. In embodiments surface imprinting and/or soft lithography may be employed so that, for example, regions of the sensor surface can be masked whilst others are activated, leading to regions of targeted chemical character.

For affinity binding, binding constants determine the stability of binding of a ligand to an immobilised host molecule. The rate at which the binding occurs informs on the nature of the binding event and can be diagnostic of competitive binding ligands. Investigation of the binding constants and binding kinetics may be helpful.

We will next outline some chromophore binding colour changes. A chromophore bound to a known DNA sequence changes colour on binding of an antisense sequence and a similar analysis can be performed for RNA sequencing. Trace sequence detection can be used for counterfeit monitoring and tracing. For example placing known sequences of DNA or RNA within a shipment can provide a DNA fingerprint of the origin of the shipment, in principle detectable by the e-CRDS techniques described herein. A multiplexed array may be employed for parallel target analysis, for example using DNA/RNA-based for multiple target detection.

For metal ion detection fluorescent molecular probes have been designed for many ions such as Ca²⁺ (as previously mentioned) and molecular probes may also be employed. These fluorescent molecules may be modified for absorption probes by tuning the absorption maximum. The system may also be employed for detection of a level population arriving in a level that is not populated directly but pumped by fluorescence and intersystem crossing to a fluorescent state. Once either is populated it may be possible to monitor the population change by absorption.

For an alternative pH sensor a silica surface may be functionalised with 3-aminopropyltrimethoxysilane providing an amino functionalisation to the surface. The indicator chromophore may then be a derivative of Medola Blue that is chemically bonded to the amino derivative on the surface. The tethered molecule can then change colour on protonation with a colour change observed as a shift in the absorbance spectrum of the molecule. This is a specific example of generic tethering technology.

Turning now to interface refreshment and stability, electrical polarity changes at the interface, mediated by a charged surface of metal or conducting polymer, can be used to reverse the potential on a surface initiating a change in the binding constant of a detected ligand. Alternative photochemical cleaning based, say, on TiO₂ may be employed. Titania absorbs light around 300 nm resulting in the generation of electrons. Subsequent oxidation of species on the surface by the electrons can be used to initiate the departure of a bound ligand to a surface. A cleaning flash of radiation from one detection event to the next is thus potentially able to refresh the sensor surface. TiO₂ comes in two forms; rutile and anatase; rutile is the most photoactive in forming electrons and is therefore preferred. Additionally or alternatively the sensor surface may be protected by a 3D interface architecture, for example to reduce the risk of poisoning the surface in a field instrument. This can be achieved by building a sensor atrium into which substantially only molecules of selected physical and chemical properties are admitted. This can be achieved by applying a potential to a porous atrium ceiling allowing positive and negatively charged species in and out of the atrium. This also represents a refreshing mechanism. Furthermore 3D architectural selectivity allows separation techniques to be brought to bear on a mesoporous material designed around the sensor atrium and, in embodiments a lab-on-a-chip although the chip may be fabricated above the atrium. This facilitates deployment in a hostile environment. Reproducibility for concentration profile monitoring may be achieved by aiming to maintain a stable detector environment within the sensor atrium.

We next describe an example of a chlorine detection system embodying aspects of the present invention. In this system the determination of attack profile (time derivative) data from initial measurement data may be performed by computer program code such as code running on the control computer 118 of FIG. 1c. This computer code may be written in any conventional language such C or Fortran, for example using conventional library modules to calculate first and/or second time derivatives of captured measurement data. We will describe a fibre optic chlorine sensor which is powered from the USB port of a laptop computer; all the laser and detection power may be derived from this source.

The sensing technology is based on a surface chemistry colour change at a fixed laser wavelength. Trials were performed under controlled laboratory conditions in a 46 litre container. A known volume of chlorine gas was introduced to the chamber and sensitivity levels of order 4 ppm were achieved in a 2-pass configuration employing evanescent wave sensing but without an optical cavity. The chlorine concentration was calibrated with a chlorine gas detection tube chlorine supplied by Rae Systems. The real-time attack profile was recorded and consistent with the injection time and diffusion dynamics for Cl₂ in a chamber of the trial dimensions. The attack profile temporal resolution achieve in real-time was 0.1 seconds, and with e-CRDS technology should be better than 0.01 seconds. Implementation of a sensor with the e-CRDS detection is also expected to increase the sensitivity to 40-4 ppb if required.

The detection technology used a fibre optic taper to monitor the absorbance change due to a chemically sensitive species on the surface of the fibre. A laser wavelength 637 mm in the red is launched into the fibre optic monitoring both the losses from the fibre optic taper and the stability of the laser. All detection laser and detection power is preferably derived from a USB port of a laptop computer which processes the data. Real-time monitoring of the sensor in the trials chamber is possible with a temporal resolution of at 0.1 seconds and a sensitivity of 0.1% for changes in the sensor response.

The sensors are based on the colour change of a molecule to the presence of Cl₂. The molecule is deposited on the surface of the tapered fibre optic simply by a dipping procedure. Along with all presumptive tests for chlorine, the gas dissolves in the solvent (water) on the surface in this example producing ClO⁻ which attacks the active sensor coating causing the colour change. In the case of crystal violet as an indicator, this removes the absorbance at 637 nm of the compound whereas for o-tolidine the absorbance at 637 nm increases.

The sensor comprises a fibre optic with the smart surface described above, FC/PC coupled directly into an interface unit. The interface is connected through the USB port to the computer from which it derives all of its power. The software interface collects the data and performs the analysis (FIG. 11a).

A field instrument is preferably ruggedised to include four sensors in a stainless steel sensor pod. One surface is a control surface; there are three live fibre optic surfaces. During a trial, one of the sensors is monitored in real-time and the two other surfaces are designed as a binary detector, alarm:not-alarm (FIG. 11b).

Sensor traces (percentage change in absorbance) and attack profiles (rate of change of percentage change in absorbance) are shown for crystal violet, FIGS. 12a, b and o-tolidine, FIGS. 13a, b. The response of the instrument has been inverted for display purposes where required.

The chlorine was injected as a pulse into the trial chamber which contained a circulation fan to establish the homogenous Cl₂ concentration. A chlorine gas detection tube from Rae systems was also used to monitor the concentration of the gas in the chamber and this found to be consistent with the injected volume.

FIG. 12 shows the crystal violet response of the sensor in part (a) and the derivative of the signal in part (b). The sensor is a cumulative sensor and rises continuously throughout the exposure. The change is not reversible at present. The attack profile is obtained by taking the derivative of this signal. The rise time or the attack is less than 5 seconds and with the circulation in the chamber, takes less than 55 second to equilibrate.

Similar experiments were performed from o-tolidine (FIGS. 13a, b) which shows a more intense signal change and is the preferred surface chemistry.

The rise time (for example measured between predetermined levels such as 10% of the peak level) for the attack profile is 2.5 seconds with an attack lasting 12.5 seconds in this trial.

Determining the attack profile is key to removing the problems of false alarms in a field scenario. The rise time and extent of the profile is determined to establish whether a true attack is to be alarmed. The confidence in this attack alarm can be improved by measuring (or modelling) the attack profile in a number of different environments: the attack profile through a private residence or hotel will be different to the attack profile for an attack on a subway system. Attack profile information can be used for initially sealing off the region of an attack to prevent propagation and managing the decontamination afterwards.

No doubt many effective variants will occur to the skilled person and it will be understood that the invention is not limited to the described embodiments but encompasses modifications apparent to those skilled in the art found within the spirit and scope of the appended claims.

1-25. (canceled)

26. A method of detecting a target substance using an optical sensor, the method comprising:
repeatedly measuring a level of said target, with said optical sensor to provide a time series of target levels;
determining a first derivative of said target level time series with respect to time; and
outputting a target detection signal responsive to a profile of said first derivative time series data.

27. A method as claimed in claim 26 wherein said optical sensor comprises a cumulative or integration sensor.

28. A method as claimed in claim 26 comprising outputting said detection signal responsive to a rise time of said profile.

29. A method as claimed in claim 26 comprising outputting said detection signal responsive to a duration of a peak in said profile.

30. A method as claimed in claim 26 wherein said sensor has a sensing region, and wherein said repeating comprises repeating at time intervals at least ten times shorter than a diffusion time of said target across said sensing region.

31. A method as claimed claim 26 wherein said detection signal is provided responsive to detection of presence of said target substance at greater than a threshold level.

32. A method as claimed in claim 26 wherein said detection signal is provided responsive to detection of absence of said target substance at greater than a threshold level.

33. A method as claimed in claim 32 further comprising determining a second derivative of said target level time series with respect to time provide second derivative time series data; and wherein said outputting of said target detection signal is responsive to said second derivative time series data.

34. A method as claimed in claim 26 further comprising determining said profile to which said outputting of said target detection signal, is responsive.

35. A method as claimed in claim 26 wherein said sensor has a plurality of target detecting regions including one or more of a control region and a binary target detection region; and wherein said detection signal outputting is responsive to signals from said plurality of regions.

36. A method as claimed in claim 26 wherein said sensor comprises a plurality of sensors having different target detection sensitivity regions.

37. A method as claimed in claim 26 wherein said target detection signal is configured to indicate both when presence of said target substance increases above a first threshold level and when presence of said target substance decreases below a second threshold level; wherein said sensor comprises two sensors, a first sensor to detect increasing presence of said target substance and a second sensor to detect decreasing presence of said target substance; and wherein said repeated measuring employs said first sensor to output said target detection signal for increasing presence of said target substance and said second sensor decreasing presence of said target substance.

38. A method as claimed in claim 26 wherein a said optical sensor comprises one or more of an optical cavity absorption sensor, an evanescent wave optical sensing device, a cavity ring-down sensor, and an evanescent wave cavity ring-down sensor.

39. A carrier carrying processor control code to, when running, implement the method of claim 26.

40. A method of detecting a target substance using a plurality of optical sensors, the method comprising; disposing said optical sensors, spaced apart, along a path; employing the method of any preceding claim to provide a target detection signal from each said sensor; and outputting a combined target detection signal responsive to a combination of signals from each sensor indicating motion of said target substance along said path.

41. A method as claimed in claim 40 wherein a said optical sensor comprises one or more of an optical cavity absorption sensor, an evanescent wave optical sensing device, a cavity ring-down sensor, and an evanescent wave cavity ring-down sensor.

42. A carrier carrying processor control code to, when running, implement the method of claim 40.

43. Apparatus for detecting a target substance using an optical sensor, the apparatus comprising:
an input to receive a signal from said optical sensor;
means to repeatedly determine a level of said target with said optical sensor to provide a time series of target levels;
means to determine a first derivative of said target level time series with respect to time to provide first derivative time series data; and
means to output a target detection signal responsive to a profile of said first derivative time series data.

44. Apparatus as claimed in claim 43 including said optical sensor.

45. Apparatus as claimed in claim 44 wherein said optical sensor comprises a cumulative or integration sensor.

46. Apparatus as claimed in claim 44 wherein said sensor has a first sensing region for sensing an increasing level of said target substance and a second sensing region for sensing a decreasing level of said target substance.

47. Apparatus as claimed in claim 43 wherein said target detection signal is further responsive to a rate of change of said first derivative of said target level time series.

48. Apparatus as claimed in claim 43 wherein said optical sensor comprises one or more of an optical cavity absorption sensor, an evanescent wave optical sensing device, a cavity ring-down sensor, and an evanescent wave cavity ring-down sensor.

49. Apparatus as claimed in claim 43 configured to make said repeated target level determinations at a frequency of at least 10 Hz.

50. Apparatus as claimed in 43 for use with a plurality of sensors dispersed along a path, the apparatus further comprising means to output said target detection signal responsive to signals from said sensors indicating motion of a target substance along said path.

51. Apparatus as claimed in claim 43 comprising a processor, data memory, program memory storing processor control code, and a processor coupled to said data memory and to said program memory, and wherein said means comprise said processor control code.

52. Apparatus for detecting a target substance using an optical sensor, the apparatus comprising computer program code for:
repeatedly measuring a level of said target, with said optical sensor to provide a time series of target levels;
determining a first derivative of said target level time series with respect to time; and
outputting a target detection signal responsive to a profile of said first derivative time series data.
